(19) United States
(12) Patent Application Publication
(10) Pub. No.: US 2023/0394568 A1
(43) Pub. Date: Dec. 7, 2023

(54) CREDIT LIMIT TRANSFER

(71) Applicant: Stoen MOLLMAN, Sioux Falls, SD (US)

(72) Inventor: Stoen MOLLMAN, Sioux Falls, SD (US)

(21) Appl. No.: 18/206,107

(22) Filed: Jun. 6, 2023

Related U.S. Application Data
(60) Provisional application No. 63/349,301, filed on Jun. 6, 2022.

(51) Int. Cl. G06Q 40/03

(52) U.S. Cl. CPC G06Q 40/03

(57) ABSTRACT

A system and method enable leveraging user credit for use by other users over a peer-to-peer platform. The system and method enable lenders to link the platform to at least one lender resource, identify lender credit utilization for each lender, and determine an amount of credit available. The system and method identify a credit score for the borrower and enable the borrower to request a loan for a specified amount if the credit score exceeds a predetermined threshold. One or more of the lenders that meet lending criteria for the borrower are identified and displayed to the borrower. The borrower can then select a lender, and the system subsequently accesses one of the lender resources and delivers the specified amount or a portion of the specified amount to the borrower.

### CROSS-REFERENCES TO RELATED APPLICATIONS

This application claims the benefit of U.S. Provisional Patent Application No. 63/349,301, filed Jun. 6, 2022, the entire content of which is herein incorporated by reference.

### STATEMENT REGARDING FEDERALLY SPONSORED RESEARCH OR DEVELOPMENT

(Not Applicable)

### BACKGROUND

The invention relates to credit sharing and, more particularly, to a peer-to-peer (P2P) factoring platform that allows users to leverage their existing credit.

P2P money transmitters are services or platforms that facilitate the direct transfer of funds between individuals, typically through electronic means, without the need for a traditional intermediary like a bank. P2P money transmitters have gained popularity due to their convenience, speed, and often lower fees compared to traditional banking services.

Examples of P2P money transmitters include Venmo, PayPal, Square's Cash App, and Zelle. While these services offer valuable features, they lack opportunities for users to leverage their own credit to generate income.

### SUMMARY

The P2P platform of the described embodiments allows users to leverage their existing credit. The platform enables users to connect with other users to allow them to use their existing credit in exchange for goods and services needed by customers. Also, in return, the user can generate income with interest earned.

In some embodiments, the user may be permitted to use up to 30% of available credit to factor out to others. This is also a common term for utilization. For example, if the user has $10,000 of available credit to use, the user could then factor up to $3,000 to others.

It is common for consumers to have more than one credit card. In an exemplary application, assuming a user has a $10K credit limit on a credit card, the user can then offer up to $3K for other users. The other users, rather than seeking an expensive payday loan for example, can receive via a transfer a certain amount (e.g., $500) of the user's credit limit, particularly if the user does not use his/her full limit and/or the transfer is under the user's 30% utilization rate.

The user is still responsible for the funds factored against the consumer's credit line. As such, when the credit borrower pays off the loan, the user's creditworthiness goes up, which is a benefit to the user. If the borrower does not pay off the loan, there would be a resulting negative impact. The risk of non-payment can be hedged by the user charging a higher interest rate than the consumer's credit card provider, while still saving the borrower the higher costs of a payday loan.

In an exemplary embodiment, a method of leveraging user credit for use by other users over a peer-to-peer platform includes the steps of (a) a server enabling lenders to log in to the platform; (b) the server enabling each of the lenders to link the platform to at least one lender resource; (c) the server identifying lender credit utilization for each lender for the at least one lender resource and determining an amount of credit available of each lender for lending; (d) the server enabling a borrower to log in to the platform; (e) the server identifying a credit score for the borrower; (f) if the credit score exceeds a predetermined threshold, the server enabling the borrower to request a loan for a specified amount; (g) the server identifying one or more of the lenders that meet lending criteria for the borrower; (h) the server displaying to the borrower the one or more of the lenders identified in step (g); (i) the server enabling the borrower to select a selected lender from the one or more lenders identified in step (g); and (j) the server accessing one of the at least one lender resource of the selected lender and delivering the specified amount or a portion of the specified amount to the borrower.

In another exemplary embodiment, a non-transitory computer-readable medium stores instructions that, when executed by a computer server, cause the computer server to perform the method of leveraging user credit for use by other users over a peer-to-peer platform.

In yet another exemplary embodiment, a device includes a memory storing computer executable instructions to perform a method of leveraging user credit for use by other users over a peer-to-peer platform, and processing circuitry, coupled with the memory, that is configured to execute the computer executable instructions to effect the described methodology.

### BRIEF DESCRIPTION OF THE DRAWINGS

These and other aspects and advantages will be described in detail with reference to the accompanying drawings, in which:

FIGS. 1 and 2 show exemplary sign in or sign up procedures for the platform;

FIG. 3 shows steps for adding resources to a user account;

FIG. 4 shows borrower options;

FIG. 5 shows lender options;

FIGS. 6-12 are exemplary screenshots illustrating the procedures and methodology in the flowcharts of FIGS. 1-5; and

FIG. 13 is a block diagram of an exemplary configuration of a computer system in which the P2P platform of the described embodiments may be implemented.

### DETAILED DESCRIPTION

A technical problem exists in that prior to the platform of the described embodiments, there has been no vehicle enabling everyday consumers to monetize available credit and/or share available credit with other consumers. The present platform provides a technical solution to this technical problem by identifying available user credit and enabling the user to access available credit for sharing with other users while generating revenue for leveraged credit. The system identifies characteristics of lenders and borrowers to find a suitable match and reduce risk.

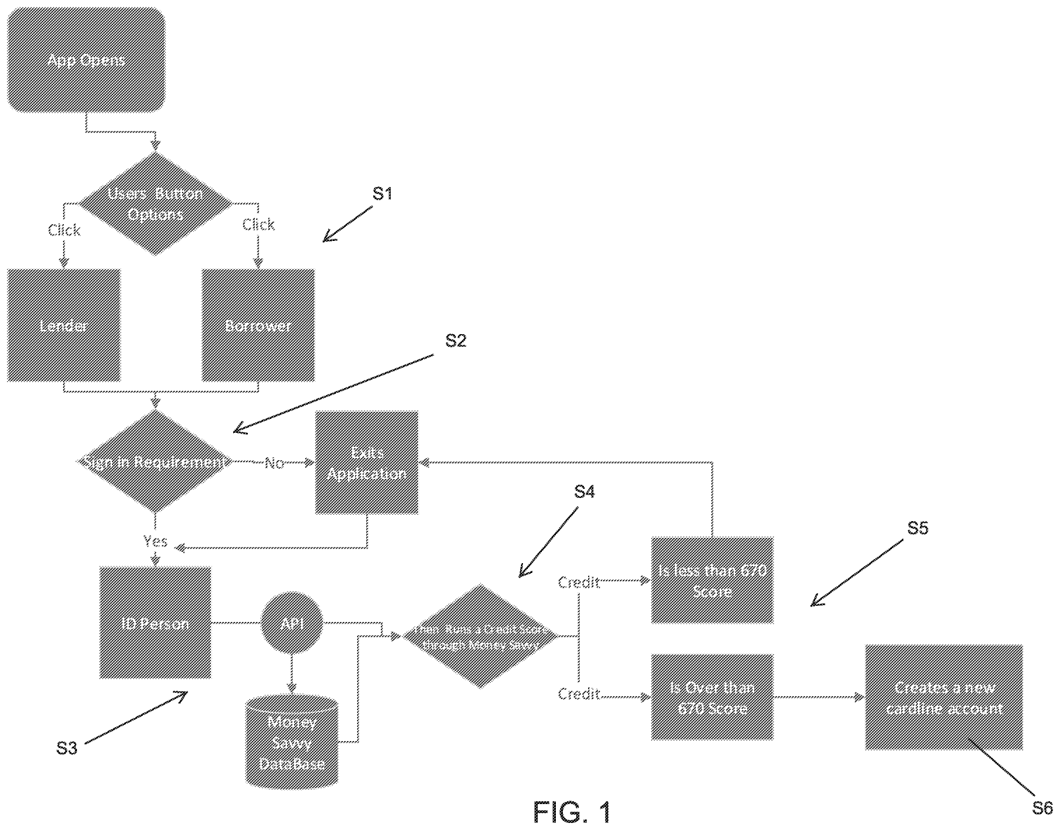

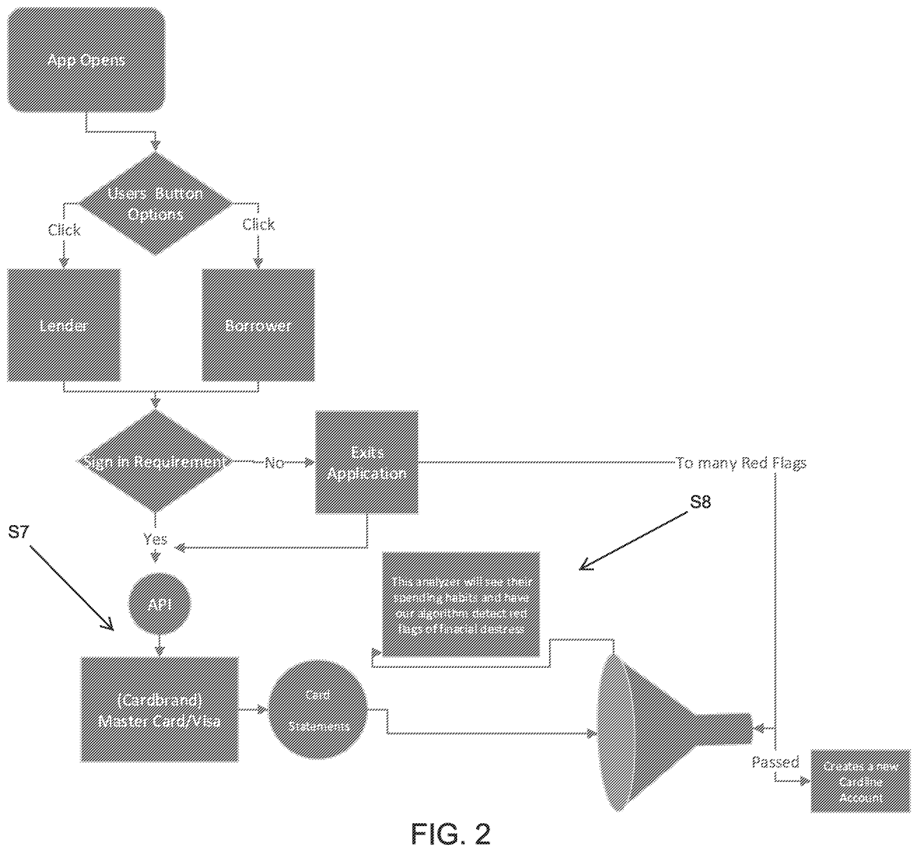

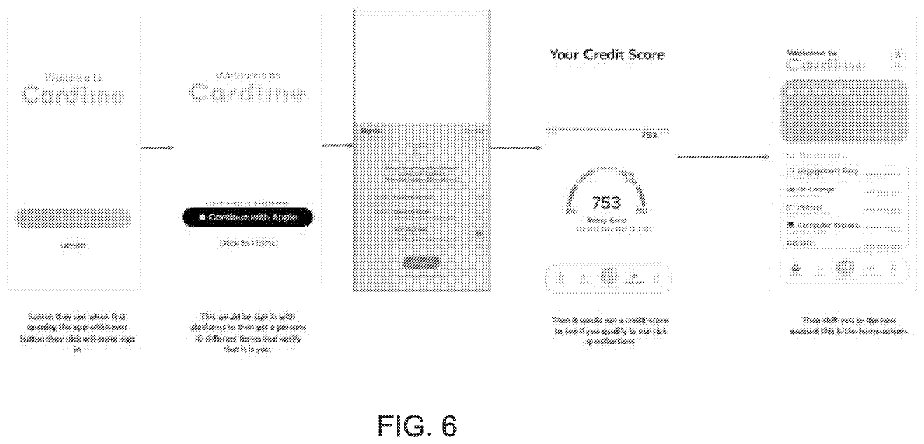

FIGS. 1 and 2 are exemplary flow diagrams for creating a new user account. After accessing the platform (i.e., opening the app), the user is presented with options for proceeding as a lender or as a borrower (51). Once selected, the platform enables the user to sign in or create a new account (S2). If the user does not wish to sign in or create a new account, the application exits. Otherwise, the application accesses an API key or the like to identify or authenticate the user (S3). The use of API keys for identification or authentication of users is known, and further details will not be described. In an exemplary application, both the authentication mechanism and all sensitive API calls are encrypted. Once the user is identified and/or authenticated, the platform identifies a credit score for the user (S4), and if the user credit score is above a predefined threshold (e.g., 670) (S5), the platform creates a new account (S6). The platform will access credit scoring software for this purpose. For example, the server may connect with API Savvy Money, which is one example of a credit scoring software. Otherwise, the user is denied access to the platform, and the system exits the application. See FIG. 6.

FIG. 2 shows a variation of the sign in or registration process where the API key identifies the user through one or more lender resources such as credit cards or the like (S7). The server identifies lender credit utilization for each of the lender resources identified by the user, and the system determines an amount of credit available for lending, i.e., credit utilization. In this context, the platform is authorized to query card brand APIs for available credit. Similar to the consumer application querying the platform server for information, the platform server will query upstream providers for real-time consumer data over an encrypted medium. With access to the lender resources, the server identifies and analyzes user spending habits to identify potential flags relating to financial distress (S8). Similar to the consumer credit scoring models, the platform server will query existing data brokerage services programmatically to identify and associate both consumer and lender risk models on the platform. This process will rely on multiple data feeds and a tuned algorithm to determine risk levels. The system uses predefined criteria to determine whether the user passes the analysis.

Factors utilized by the algorithm include:
Inability to Pay Bills on Time: Consistent late payments or bills going to collections are strong indicators of financial distress. This might include utility bills, rent or mortgage payments, and other obligations.
Maxed Out Credit Cards: If credit cards are consistently maxed out for a period of, for example, two years, and the debt is not being paid down, it can be a warning sign of financial trouble.
Relying on Loans to Pay Bills: Regularly relying on short-term loans or cash advances to meet basic expenses indicates that income isn't sufficient to cover costs.
Inability to Save or Afford Emergencies: Not having a savings buffer for emergencies is a key indicator that a user is living paycheck-to-paycheck and may not be able to manage an unexpected expense.
Overwhelming Stress About Finances: If stress about money is consuming thoughts and affecting health or relationships, it may be a sign that the situation is serious.
Legal Action from Creditors: If creditors are taking legal action to recoup money owed, like lawsuits or wage garnishment, this is a serious sign of financial distress.
Ignoring or Unaware of the Extent of the Debt Problem: Sometimes, people in serious debt may be in denial about the extent of their situation, or they may be so overwhelmed that they ignore their bills entirely.
Only Making Minimum Payments: If the user is only making the minimum payments on credit cards, the overall balance isn't decreasing much due to the high interest rates. Over time, it may become increasingly difficult to pay off debt.
Late Payments or Missed Payments: Consistently making late payments or missing payments entirely can lead to late fees, higher interest rates, and a lower credit score. This can also indicate that the user is struggling to manage debt.
Applying for New Credit Cards to Pay off Old Ones: If the user is regularly applying for new credit cards to transfer balances and take advantage of introductory interest rates, this might be a sign that the user is struggling to pay off existing debt.
Relying on Credit Cards for Necessities: If the user is using credit cards to pay for basic necessities like food and rent, this could be a sign that the user is living beyond his/her means and could be heading toward bankruptcy.
Ignoring Credit Card Statements: If the user is avoiding credit card statements because the user refuses to confront growing debt, this could be a warning sign.
Credit Card Companies Are Closing Your Accounts: If lenders are closing accounts due to payment behavior, this is a significant sign of financial distress.

These factors can be measured or determined using publicly available resources, credit resources, social media, and other subscription or paid resources.

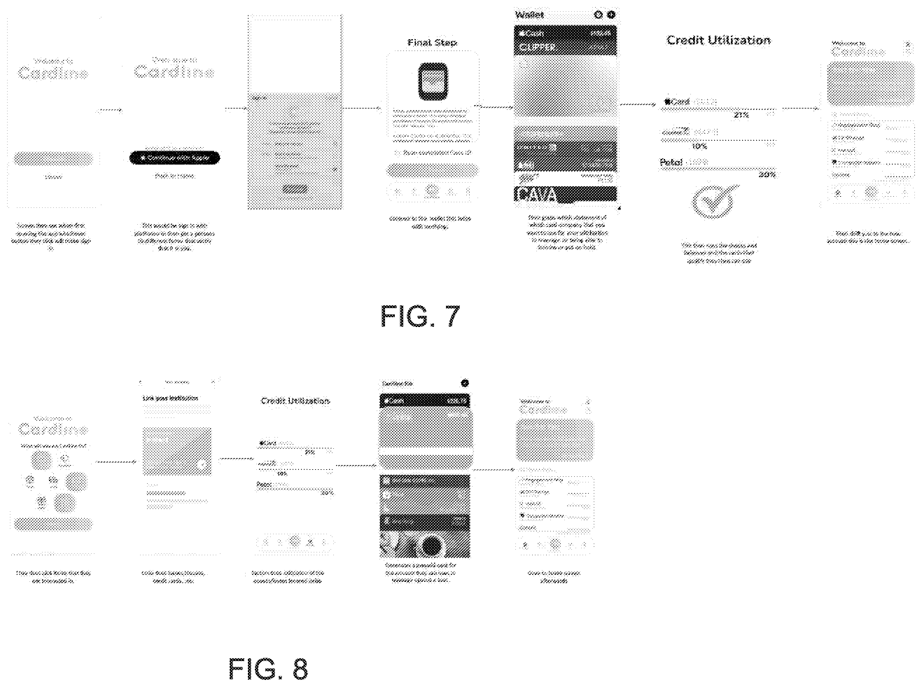

If the result of the analysis is positive, the system creates a new account for the user. Otherwise, the user is provided an indication that they do not qualify, and the system exits the application. See FIG. 7.

Passing the analysis can be configured to suit platform and/or regulatory requirements. Other actions taken by the server to determine this metric may include looking at a user's statement and identifying the frequency of what is considered as bad debt. Also, the server may review user credit card statements to identify a credit increase and the effect of the credit increase on user purchasing activity.

This process performed by the server would also help the platform then consider what type of spender the user is, whether they are experiencing financial stress and/or user risk profile. For example, the user may not put anything on their card or the user may like to use the most of their credit card. In the implementation of the software on the current platform, as the system takes care of comprehensive personal data analysis (using data science/machine learning tools) over time, the analysis will help/guide the platform to manage expected yield.

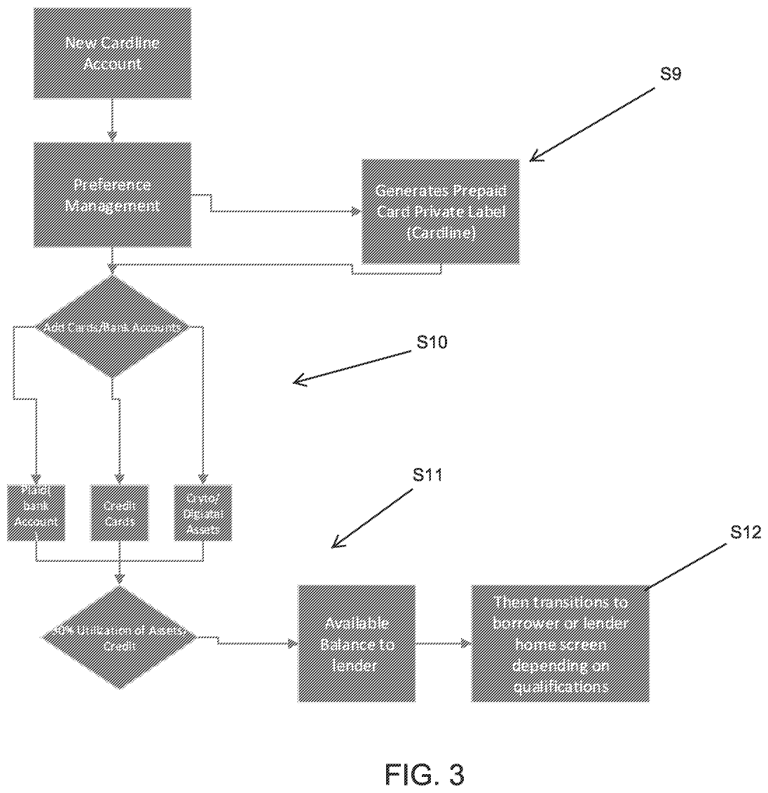

FIG. 3 shows the steps conducted by the server to identify an amount of credit available to the user for lending. After logging into the system, the server generates a prepaid card private label in the form of a virtual debit card that is charged with the user's available credit (S9). The user identifies lender resources with credit available for lending, and the server links the application to the lender resources (S10). Exemplary lender resources include credit cards, bank accounts, crypto/digital assets and the like. In an exemplary application, a maximum credit utilization for determining the amount of credit available is 30%. On this criteria, the server identifies an amount of credit available for lending, which amount is applied to the prepaid card private label (S11). The user is then directed to the home screen (S12). See FIG. 8.

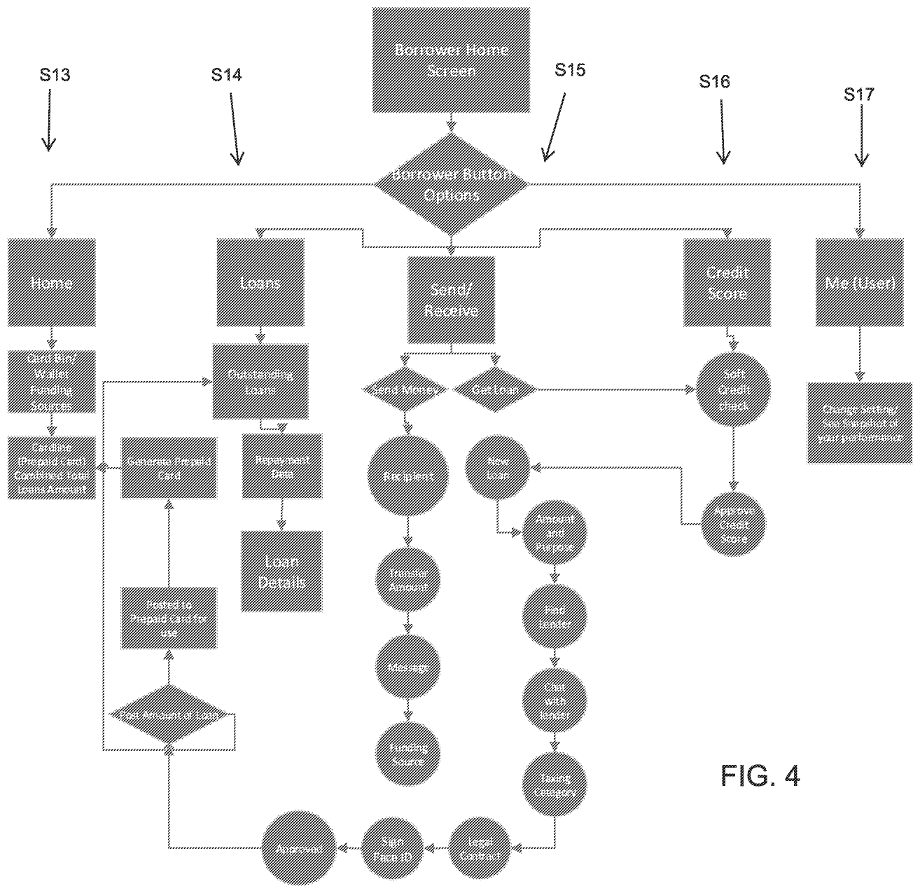

At the home screen, users are provided the option to proceed as a borrower or lender. See the first screenshots in FIGS. 6 and 7. FIG. 4 shows options made available by the server when the user selects the borrower option. At any time, the user can link additional lender resources to the platform account (S13). The user can access outstanding loans including loan details with options to repay in full or in part any outstanding loans (S14).

Borrowers are also provided an option to send funds to other users or in payment of outstanding loans or apply for additional loans (S15). In sending money, the user identifies the recipient, the transfer amount, and includes any message to the recipient. The user also identifies a funding source from the sources linked to the platform account. If the user is instead securing funds for a loan, the system conducts an updated credit check, and assuming the credit score exceeds a predetermined threshold, the system proceeds with processing the new loan. The system asks the user to identify the desired amount and purpose for the loan, and the server identifies one or more lenders that meet specific lending criteria for the borrower. The server displays to the borrower the one or more of the identified lenders, enabling the borrower to select a selected lender from the one or more identified lenders. The platform includes a chat feature in the event that the borrower or lender has questions or requires additional information before approving the loan. The borrower can identify a taxing category for the funds, e.g., business, personal, other. Once the terms are acceptable to both parties, a contract is generated, user IDs are confirmed, and the transaction is processed. In this context, the server accesses the lender resource of the selected lender and delivers the specified amount or a portion of the specified amount to the borrower.

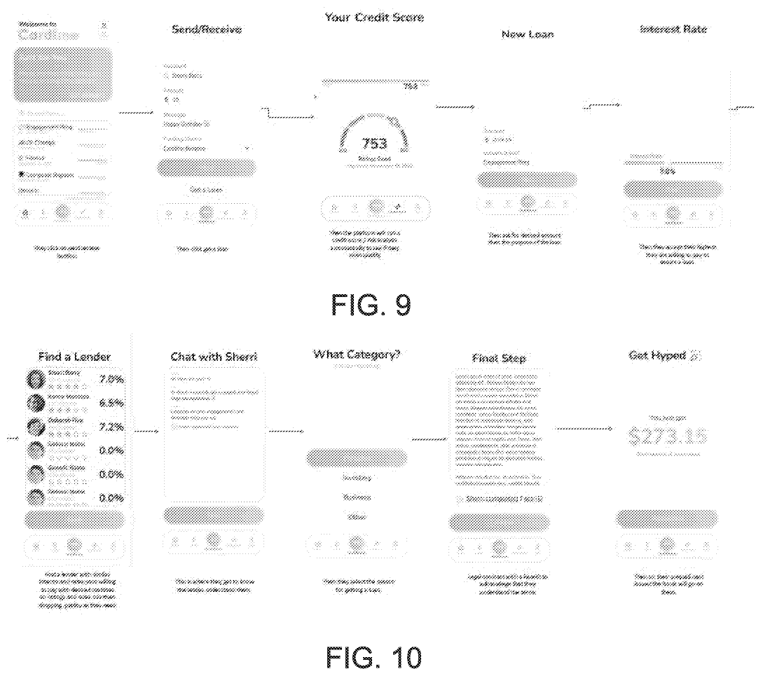

With continued reference to FIG. 4, the system provides the user with the option to check their credit score (S16), and there is a path for the user to change or update platform settings (S17). Screenshots associated with the flow diagram in FIG. 4 are shown in FIGS. 9 and 10.

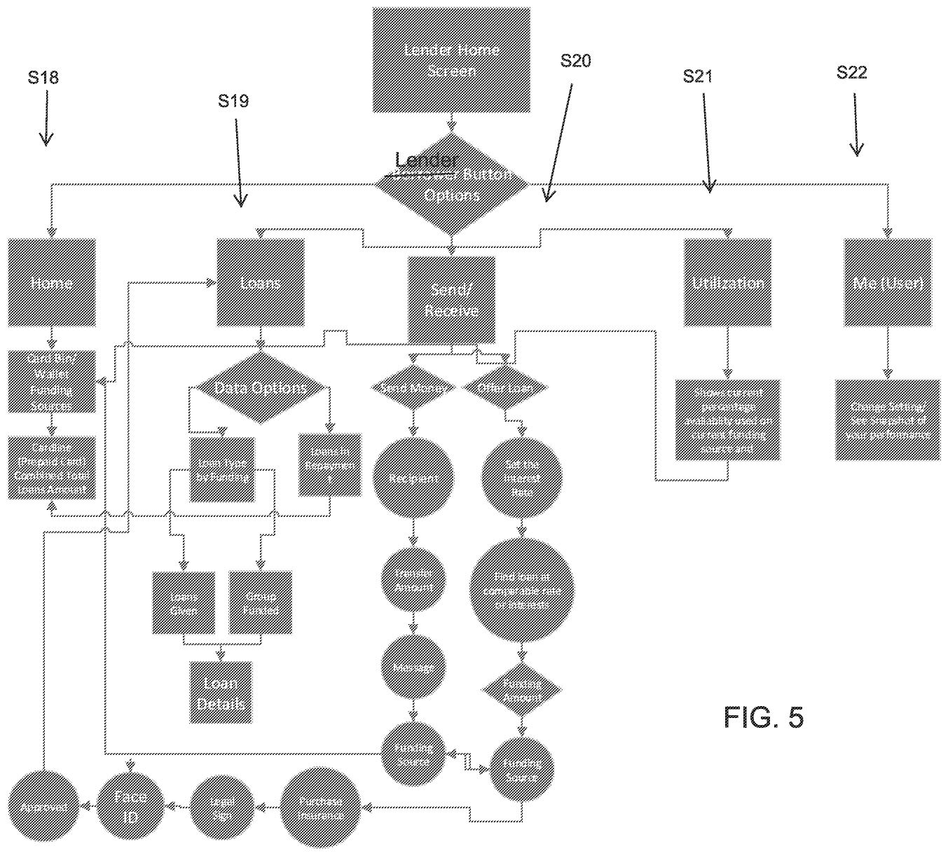

FIG. 5 shows the system flow process when the user selects the lender button from the homepage. Like the borrower process, lenders are provided with an option to add or modify lender resources linked with the platform (S18).

The user can check the status of existing loans (S19). The platform can identify/determine what the lender and borrower want to see loans by type and loans in repayment and payback period. The buttons are loans by type and loans in repayment.

The user/lender is provided with options to send money/credit (S20). The user identifies the recipient, the transfer amount and is provided with an option to include a message. Subsequently, the system accesses the user's lender resource, and the funds are transferred.

The user can also offer a loan with available credit. The user defines loan parameters such as the interest rate, minimum borrower rating, minimum borrower credit score, etc., and the system identifies loans at comparable rates for user reference. The user then identifies a funding amount, and the system accesses one or more of the lender resources to fund the loan. In defining the loan parameters, the lender can set an interest rate or interest rate range as well as other lending criteria. For example, the lender may limit lending only to users with a certain user rating (e.g., 4/5 stars or more) or to a borrower credit score higher than the system minimum or the like. When the system identifies one or more of the lenders that meet lending criteria for a particular borrower, the system utilizes this criteria to identify one or more lenders for the particular transaction.

If a borrower selects the lender and the terms are acceptable, the borrower is provided with an insurance option, and the system generates a contract for party signatures. Subsequently, user identities are confirmed, and the transaction is approved/finalized. In some applications, the lender may be required to buy insurance, so if the borrower defaults, the lender will recoup a percentage of the initial loan amount, and the system administrator will be repaid a percentage of the initial loan back to the lender based on the percentage purchased by the lender. Subsequently, the amount of reinsurance purchases will go back on the lender prepaid card. This is also known as reinsurance for lenders. The reinsurer will be a third-party vendor or an insurance company hosted by the system administrator.

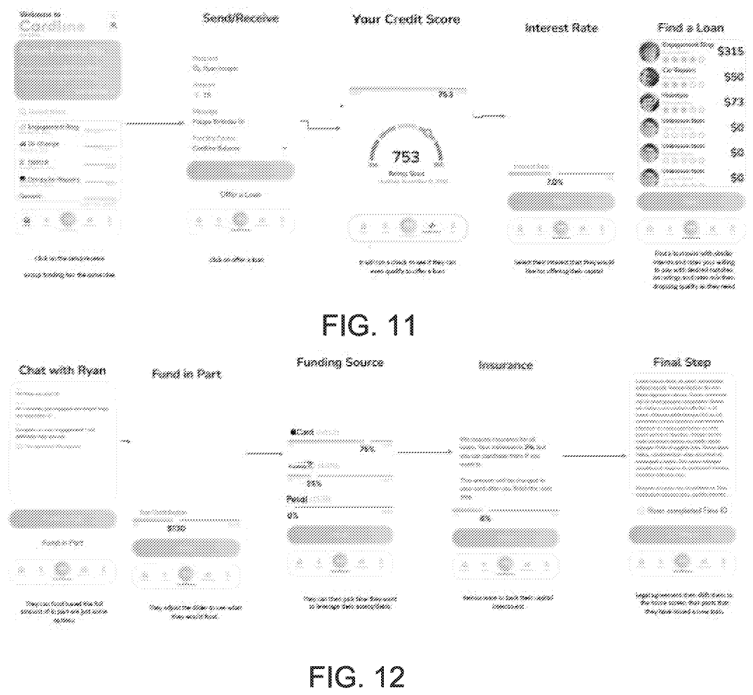

Lenders also have an option at any time to check the amount of credit available for lending (S21). Also from the lender homepage, users can update system settings (S22). Exemplary screenshots from the flow process shown in FIG. 5 are provided in FIGS. 11 and 12.

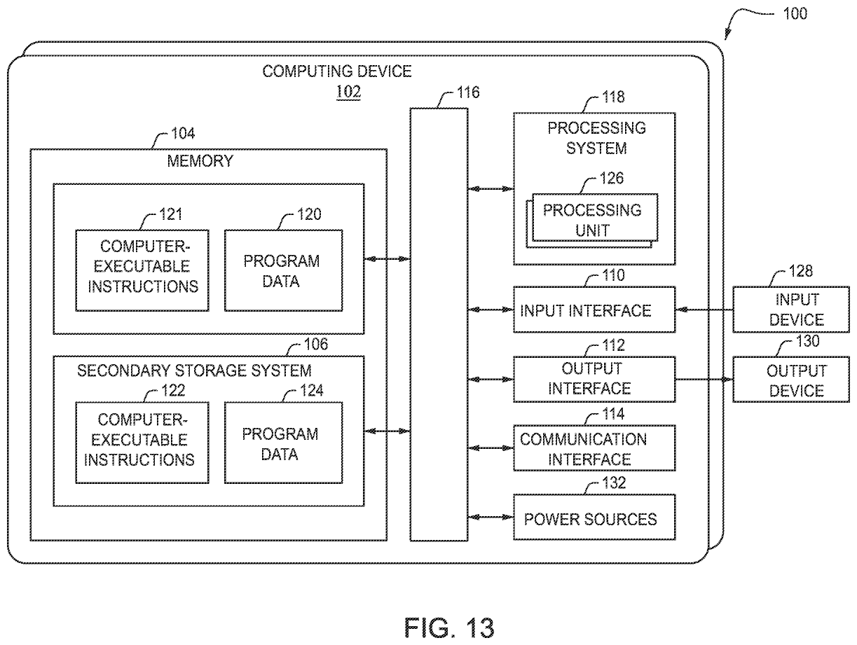

In some applications, the P2P platform of the described embodiments is administered using a computer system. Any known computer configuration capable of carrying out the intended functionality of the preferred embodiments may be used. FIG. 13 is a block diagram of an example configuration of a computer system 100 in which the techniques of this disclosure may be implemented. In the example of FIG. 13, computer system 100 comprises a computing device 102 and one or more other computing devices. Computer system 100 or similar computing systems implement the P2P platform 10. Computing device 102 is an electronic device that processes information. In the example of FIG. 13, computing device 102 comprises a data storage system 104, a memory 108, a secondary storage system 106, a processing system 118, an input interface 110, an output interface 112, a communication interface 114, one or more power sources 132, and one or more communication media 116. Communication media 116 enable data communication between processing system 118, input interface 110, output interface 112, communication interface 114, memory 108, and secondary storage system 106. Computing device 102 can include components in addition to those shown in the example of FIG. 13. Furthermore, some computing devices do not include all of the components shown in the example of FIG. 13. Each of components 104, 106, 108, 110, 112, 114, 116, 118, 120, 121, 122, 124, 126, 128, 130, and 132 can be interconnected (physically, communicatively, or operatively) for inter-component communications.

Data storage system 104 is a system that stores data for subsequent retrieval. In the example of FIG. 13, data storage system 104 comprises memory 108 and secondary storage system 106. Memory 108 and secondary storage system 106 store data for later retrieval. In the example of FIG. 13, memory 108 stores computer-executable instructions 121 and program data 120. Secondary storage system 106 stores computer-executable instructions 122 and program data 124. Physically, memory 108 and secondary storage system 106 each comprise one or more computer-readable storage media.

A computer-readable medium is a medium from which a processing system can read data. Computer-readable media include computer storage media and communications media. Computer storage media can further include physical devices that store data for subsequent retrieval. Computer storage media are not transitory. For instance, computer storage media do not exclusively comprise propagated signals. Computer storage media include volatile storage media and non-volatile storage media. Example types of computer storage media include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media includes media over which one device can communicate data to another device. Example types of communication media include communication networks, communications cables, wireless communication links, communication buses, and other media over which one device is able to communicate data to another device.

Referring again to FIG. 13, processing system 118 is coupled to data storage system 104. Processing system 118 reads computer-executable instructions (e.g., 121, 122) from data storage system 104 and executes the computer-executable instructions. Execution of the computer-executable instructions by processing system 118 configures and/or causes computing device 102 to perform the actions indicated by the computer-executable instructions. For example, execution of the computer-executable instructions by processing system 108 can configure and/or cause computing device 102 to provide Basic Input/Output Systems (BIOS), operating systems, system programs, application programs, or can configure and/or cause computing device 102 to provide other functionality.

Processing system 118 reads the computer-executable instructions from one or more computer-readable media. For example, processing system 118 reads and executes computer-executable instructions 121 and 122 stored on memory 108 and secondary storage system 106.

Processing system 118 comprises one or more processing units 126. Processing units 126 comprise physical devices that execute computer-executable instructions. Processing system 118 can also include one or more operating systems that are executable by computing device 102. Processing units 126 comprise various types of physical devices that execute computer-executable instructions. For example, one or more of processing units 126 comprise a microprocessor, a processing core within a microprocessor, a digital signal processor, a graphics processing unit, or another type of physical device that executes computer-executable instructions.

Input interface 110 enables computing device 102 to receive input from an input device 128. Input device 128 comprises a device that receives input from a user. Input device 128 comprises one or more various types of devices that receive input from users. For example, input device 128 comprises a keyboard, a touch screen, a mouse, a microphone, a keypad, a joystick, a brain-computer interface device, or another type of device that receives input from a user. In some examples, input device 128 is integrated into a housing of computing device 102. In other examples, input device 128 is outside a housing of computing device 102.

Output interface 112 enables computing device 102 to output information on one or more output devices 130. One or more output devices 130, in some examples, are configured to provide output to a user using tactile, audio, or video output. For example, an output device 130 is a device that displays output. Example types of display devices include monitors, touch screens, display screens, televisions, and other types of devices that display output. In some examples, output device 130 is integrated into a housing of computing device 102. In other examples, output device 130 is outside a housing of computing device 102. Output devices 130, in one example, includes a presence-sensitive screen or a touch screen. Output devices 130 can utilize a sound card, a video graphics adapter card, or any other type of device for converting a signal into an appropriate form understandable to humans or machines. Additional examples of output device 130 include a speaker, a cathode ray tube (CRT) monitor, a liquid crystal display (LCD), or any other type of device that can generate intelligible output to a user.

Communication interface 114 enables computing device 102 to send and receive data over one or more communication media. In some examples, computing device 102 utilizes one or more communication interfaces 114 to wirelessly communicate with an external device such as server device or a client device, a mobile phone, or other networked computing device. Communication interface 114 comprises various types of devices. For example, communication interface 114 comprises a Network Interface Card (NIC), a wireless network adapter, a Universal Serial Bus (USB) port, or another type of device that enables computing device 102 to send and receive data over one or more communication media. In some examples, communications interface 114 comprises a network interface to communicate with external devices via one or more networks, such as one or more wireless networks. Examples of communications interface 114 are an Ethernet card, an optical transceiver, a radio frequency transceiver, or any other type of device that can send and receive information. Other examples of such network interfaces include Bluetooth®, 3G and Wi-Fi® radios in mobile computing devices. In some examples, communication interface 114 receives configuration data, trial data, and/or other types of data as described above. Furthermore, in some examples, communication interface 114 outputs information and/or other types of data as described above.

Computing device 102, in some examples, includes one or more power sources 132, which may be rechargeable and provide power to computing device 102. In some examples, the one or more power sources 132 are one or more batteries. The one or more batteries could be made from nickel-cadmium, lithium-ion, or any other suitable material. In another example, the one or more power sources 132 include a power supply connection that receives power from a power source external to computing device 102.

The techniques described herein may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described herein may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

The P2P platform of the described embodiments connects and assesses lenders and borrowers alike, ensuring accessible credit for the creditable. The platform accesses user lending resources enabling users to make money by using their own form of credit in exchange for payment. The platform provides user borrowers with access to funds and enables user lenders to convert credit via a current medium of exchange into profit.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of leveraging user credit for use by other users over a peer-to-peer platform, the method comprising:
(a) a server enabling lenders to log in to the platform;
(b) the server enabling each of the lenders to link the platform to at least one lender resource;
(c) the server identifying lender credit utilization for each lender for the at least one lender resource and determining an amount of credit available of each lender for lending;
(d) the server enabling a borrower to log in to the platform;
(e) the server identifying a credit score for the borrower;
(f) if the credit score exceeds a predetermined threshold, the server enabling the borrower to request a loan for a specified amount;
(g) the server identifying one or more of the lenders that meet lending criteria for the borrower;
(h) the server displaying to the borrower the one or more of the lenders identified in step (g);
(i) the server enabling the borrower to select a selected lender from the one or more lenders identified in step (g); and
(j) the server accessing one of the at least one lender resource of the selected lender and delivering the specified amount or a portion of the specified amount to the borrower.

2. A method according to claim 1, wherein step (b) is practiced by the server enabling each of the lenders to link the platform to a lender credit card.

3. A method according to claim 1, wherein step (c) is practiced by the server communicating with a credit scoring software provider against API endpoints.

4. A method according to claim 3, wherein a maximum credit utilization for determining the amount of credit available is 30 percent.

5. A method according to claim 1, wherein step (e) is practiced by the server accessing a credit scoring software provider.

6. A method according to claim 1, wherein the threshold credit score is 670.

7. A method according to claim 1, further comprising, prior to step (g), the server enabling the lender to define loan parameters and the server enabling the borrower to define the lending criteria, wherein step (g) is practiced by identifying one or more of the lenders that satisfy the lending criteria defined by the borrower based on the loan parameters defined by the lender.

8. A method according to claim 1, wherein step (j) is practiced by the server facilitating funds transfers between the borrower and the lender through automated procedures for authorized funds approval processes.

9. A non-transitory computer-readable medium storing instructions that, when executed by a computer server, cause the computer server to perform a method of leveraging user credit for use by other users over a peer-to-peer platform, the computer-readable medium causing the computer server to:
(a) enable lenders to log in to the platform;
(b) enable each of the lenders to link the platform to at least one lender resource;
(c) identify lender credit utilization for each lender for the at least one lender resource and determine an amount of credit available of each lender for lending;
(d) enable a borrower to log in to the platform;
(e) identify a credit score for the borrower;
(f) if the credit score exceeds a predetermined threshold, enable the borrower to request a loan for a specified amount;
(g) identify one or more of the lenders that meet lending criteria for the borrower;
(h) display to the borrower the one or more of the lenders identified in step (g);
(i) enable the borrower to select a selected lender from the one or more lenders identified in step (g); and
(j) access one of the at least one lender resource of the selected lender and delivering the specified amount or a portion of the specified amount to the borrower.

10. A device comprising:
a memory storing computer executable instructions to perform a method of leveraging user credit for use by other users over a peer-to-peer platform; and
processing circuitry, coupled with the memory, that is configured to execute the computer executable instructions to:
(a) enable lenders to log in to the platform;
(b) enable each of the lenders to link the platform to at least one lender resource;
(c) identify lender credit utilization for each lender for the at least one lender resource and determine an amount of credit available of each lender for lending;
(d) enable a borrower to log in to the platform;
(e) identify a credit score for the borrower;
(f) if the credit score exceeds a predetermined threshold, enable the borrower to request a loan for a specified amount;
(g) identify one or more of the lenders that meet lending criteria for the borrower;
(h) display to the borrower the one or more of the lenders identified in step (g);
(i) enable the borrower to select a selected lender from the one or more lenders identified in step (g); and
(j) access one of the at least one lender resource of the selected lender and delivering the specified amount or a portion of the specified amount to the borrower.
